(19) United States
(12) Patent Application Publication
(10) Pub. No.: US 2026/0227748 A1
(43) Pub. Date: Aug. 6, 2026

(54) ASSET HEALTH ASSESSMENT IN INDUSTRIAL NETWORKS

(71) Applicant: Honeywell International Inc., Charlotte, NC (US)

(72) Inventors: Alexey (Eli) Khitrov, Tel Aviv (IL); Alexander Zelichenko, Kochav Yair (IL); Adam Engelhart, Bruchin (IL)

(21) Appl. No.: 19/042,034

(22) Filed: Jan. 31, 2025

(51) Int. Cl. G05B 13/02; G05B 23/02

(52) U.S. Cl. CPC G05B 13/021; G05B 23/027

(57) ABSTRACT

Techniques for performing asset health assessment in industrial networks are described. In an example, a plurality of data streams is received, where the plurality of data streams includes a plurality of data packets associated with an asset within an industrial facility, where the plurality of data packets includes a plurality of variables indicative of operating parameters of the asset. The plurality of data streams is then processed for obtaining a first batch of pre-processed data packets corresponding to each of the plurality of data streams. The first batch of pre-processed data packets includes a first set of values of a first variable from the plurality of variables. The first batch of pre-processed data packets are then merged to obtain a second batch of data packets. Thereafter, data packets within the second batch of data packets are sorted to obtain a serialized ordered list of values. Subsequently, the serialized ordered list of values may be used to generate an adaptive baseline for the first variable.

### BACKGROUND

Industrial facilities encompass complex arrangements of interconnected assets, where each of the interconnected assets play a crucial role in various industrial operations. The assets are usually configured to operate based on specific requirements tailored to the various industrial processes. Consequently, efficient operation and maintenance of the assets is paramount for ensuring optimal productivity, maintaining safety standards, and upholding quality metrics associated with the multitude of industrial processes.

### BRIEF DESCRIPTION OF DRAWINGS

FIG. 1 illustrates an environment for implementing an Asset Health Assessment System (AHAS), in accordance with an example of the present subject matter,

FIG. 2 illustrates schematic of the AHAS, in accordance with an example of the present subject matter,

FIG. 3 illustrates the schematic of the AHAS, in accordance with another example of the present subject matter,

FIG. 4 illustrates a method for performing asset health assessment, in accordance with an example of the present subject matter,

FIG. 5 illustrates the method for performing asset health assessment, in accordance with another example of the present subject matter,

FIG. 6 illustrates the method for performing asset health assessment, in accordance with yet another example of the present subject matter,

FIG. 7 illustrates the method for performing asset health assessment, in accordance with yet another example of the present subject matter,

FIG. 8 illustrates the method for performing asset health assessment, in accordance with yet another example of the present subject matter,

FIG. 9 illustrates the method for performing asset health assessment, in accordance with yet another example of the present subject matter, and

FIG. 10 illustrates a non-transitory computer-readable medium for performing asset health assessment, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

Traditionally, to ensure efficient operation and maintenance of assets within an industrial facility, a plurality of variables indicative of various operating parameters of an asset are monitored and recorded. Such monitoring techniques often face challenges when processing large volumes of network data dealing with plurality of variables, received in real-time or near real time. Processing such vast amounts of data received every second, without compromising on the system performance and utilization of computing resources is challenging. The plurality of variables are evaluated against various predefined baselines established in accordance with specific requirements of an industrial process corresponding to the asset. The baselines represent an expected normal operating condition for the asset with respect to the industrial process and a significant deviation in a variable from a corresponding predefined baseline is generally considered an abnormality, potentially indicating a malfunction, inefficiency, or impending failure of the asset. In such cases, alarms are typically triggered to alert operators or automated systems for further investigation or initiating corrective actions.

However, traditional approaches for ensuring efficient asset operation and maintenance face several challenges. For instance, establishment and maintenance of accurate baselines require extensive domain knowledge and expertise specific to different assets and various industrial processes corresponding to the assets. In addition, manual configuration of monitoring parameters for numerous assets is time-consuming and resource-intensive, particularly in large-scale industrial settings. Further, static baselines and thresholds often fail to account for normal variations in asset behaviour over time, leading to false alarms or missed anomalies. Thus, the traditional approaches struggle to adapt to changing operational conditions, seasonal variations, or modifications in production processes, potentially compromising the accuracy of asset health assessment.

According to examples of the present subject matter, techniques for performing asset health assessment are described.

In an example, a plurality of data streams is received from a plurality of network switches included in an industrial network corresponding to an industrial facility. The plurality of data streams includes a plurality of data packets associated with an asset within the industrial facility. Further, the plurality of data packets includes a plurality of variables indicative of operating parameters of the asset.

The plurality of data streams is then processed for obtaining a first batch of pre-processed data packets corresponding to each of the plurality of data streams. The first batch of pre-processed data packets comprises a first set of values of the first variable from the plurality of variables. In an example, the processing of the plurality of data streams may include identification a first set of data packets for each of the plurality of data streams, where the first set of data packets are associated with the first variable. In the example, the processing may further include removing data packets with duplicate values of the first variable from the first set of data packets to obtain the first batch of pre-processed data packets.

The first batch of pre-processed data packets corresponding to each of the plurality of data streams are then merged to obtain a second batch of data packets. Thereafter, data packets within the second batch of data packets are sorted based at least on a timestamp of receiving the second batch of data packets to obtain a serialized ordered list of values.

Subsequently, the serialized ordered list of values may be utilized to compute at least one of a moving average of the first variable, a standard deviation with respect to the moving average, and maximum and minimum values of the first variable for generating an adaptive baseline for the first variable. The adaptive baseline for the first variable may then be referenced for determining an abnormality in functionality of the asset.

A plurality of variables associated with the asset may then be monitored to determine that a value of the first variable is beyond the adaptive baseline for the first variable. In response to the determination, a notification indicating the abnormality in the functionality of the asset may be generated.

By analysing patterns and trends directly from the plurality of variables indicative of operating parameters of the asset, the present subject matter facilities identification of abnormalities in functionality of the asset without requiring extensive understanding of the specific industrial processes corresponding to the asset. Thus, the present subject matter allows for more generalized asset health assessment across diverse industrial facilities by adapting to each asset's unique operational characteristics rather than relying on predefined baselines established for specific industrial processes. Consequently, operators with less specialized knowledge of particular industrial processes may be able to effectively monitor and maintain a wider range of assets, potentially improving operational efficiency and reducing the need for highly specialized expertise for each distinct industrial process or asset type within the industrial facility.

Further, by computing at least one of the moving average, the standard deviation, and the maximum and minimum values of the first variable, the present subject matter facilitates generation of a dynamic reference point that evolves with changing operational conditions. Such an adaptive approach may account for normal variations in asset behaviour over time, such as those caused by seasonal changes, production fluctuations, or gradual wear. As a result, the adaptive baseline provides a more accurate representation of the asset's expected performance under current conditions, potentially reducing false alarms triggered by normal operational variations while enhancing the detection of genuine abnormalities in asset functionality. The improved accuracy in asset health assessment leads to more efficient maintenance scheduling, reduced downtime, and optimized asset performance within the industrial facility.

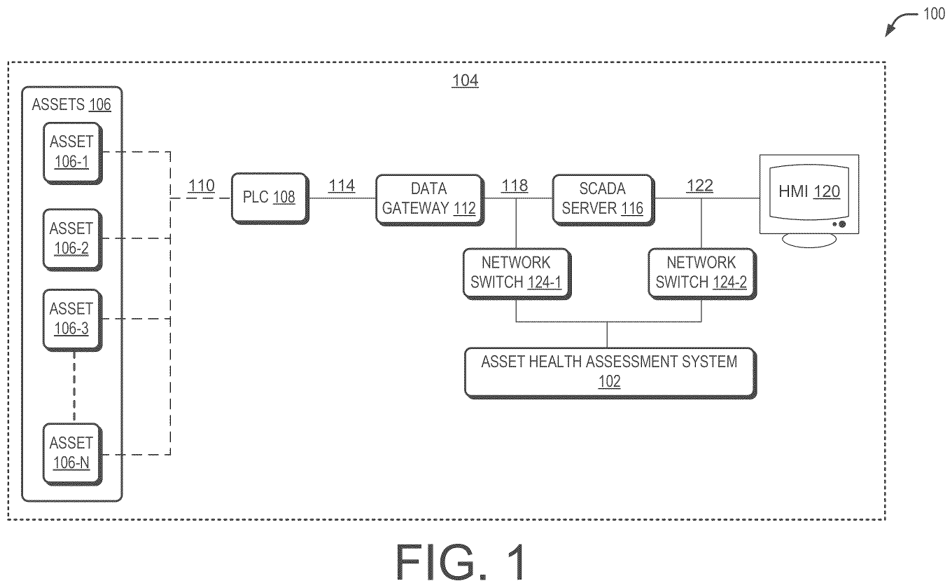

The above techniques are further described with reference to FIGS. 1 to 10. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates an environment for implementing an Asset Health Assessment System (AHAS) 102, in accordance with an example of the present subject matter.

The environment 100 may include an industrial facility 104, where the industrial facility 104 may have a plurality of assets 106-1, 106-2, 106-3, . . . , 106-n. For the ease of reference, the plurality of assets 106-1, 106-2, 106-3, . . . , 106-n has been referred to as the plurality of assets 106, hereinafter. Examples of the industrial facility 104 may include, but are not limited to, automobile assembly facilities, electronics manufacturing facilities, pharmaceutical production facilities, food processing plants, power plants, oil refineries, natural gas processing plants, steel mills, smelting plants, cement plants, water treatment facilities, wastewater treatment plants, warehouse and distribution centres, and port and shipping facilities. Further, examples of the assets 106 at the industrial facility 104 may vary based on a type of industrial facility 104 and an industrial process to be carried out at the facility. For instance, in an automobile assembly facility, assets may include robotic arms, conveyor belts, welding machines, and paint sprayers; in a pharmaceutical production facility, assets may include mixing tanks, centrifuges, tablet presses, and packaging machines; in a power plant, assets may include turbines, generators, boilers, and cooling towers; in a food processing plant, assets may include ovens, mixers, packaging machines, and refrigeration units; in a warehouse and distribution center, assets may include conveyor systems, automated guided vehicles (AGVs), sorting machines, and inventory management systems; in an oil refinery, assets may include distillation columns, heat exchangers, pumps, and compressors; and in a water treatment facility, assets may include filtration systems, chemical dosing equipment, pumps, and monitoring sensors.

Although not shown, each of the plurality of assets 106 may also be connected to each other either through a direct communication link, or through multiple communication links of a first network (not shown). The first network may be a wireless or a wired network, or a combination thereof. The first network can be a collection of individual networks, interconnected with each other and functioning as a single large network. Examples of such individual networks include, but are not limited to, Industrial Ethernet networks, fieldbus networks (e.g., Profibus, Foundation Fieldbus), wireless sensor networks (e.g., WirelessHART, ISA100.11a), Controller Area Network (CAN), Modbus networks, PROFINET, EtherCAT, DeviceNet, Open Platform Communications Unified Architecture (OPC UA) networks, Time-Sensitive Networking (TSN), Industrial Internet of Things (IIoT) networks, 5G private networks, Serial communication networks (e.g., RS-232, RS-485), and Power Line Communication networks. In some cases, the first network may also include proprietary industrial communication protocols developed by specific manufacturers for their equipment. The first network may also incorporate redundancy features, such as ring topologies or mesh networks, to ensure continuous communication even in case of network failures.

The environment 100 may further include a Programmable Logic Controller (PLC) 108 coupled to the plurality of assets 106. The PLC 108 may be coupled to the plurality of assets 106 via a first communication link 110. In an example, the first communication link 110 may be an analog communication link. Examples of the analog communication link may include, but are not limited to, 4-20 mA current loops, 0-10V voltage signals, thermocouple signals, resistance temperature detector (RTD) signals, strain gauge signals, and pneumatic control signals. In some cases, the first communication link 110 may also include other types of analog signals specific to particular industrial processes or equipment, such as pH sensor outputs, flow meter signals, or pressure transducer outputs. The analog communication link may provide continuous real-time data transmission between the PLC 108 and the plurality of assets 106, allowing for precise monitoring and control of various operational parameters.

The PLC 108 may be configured to monitor the operation of the plurality of assets 106 and issue control instructions to control the operation of each of the plurality of assets 106. For instance, the PLC 108 may receive operational data corresponding to the plurality of assets 106 from various sensors associated with the plurality of assets 106, process the operational data according to predefined logic or algorithms, and then send appropriate control signals to actuators or other control mechanisms on the plurality of assets 106.

Further, the environment 100 may include a data gateway 112 communicatively coupled to the PLC 108. The data gateway 112 may be coupled to the PLC 108 via a second communication link 114. In an example, the second communication link 114 may be include Operational Technology (OT) propriety protocols and may vary based on the manufacturers of at least one of the PLC 108 and the data gateway 112. The data gateway 112 may be designed to support multiple proprietary protocols to interface with PLCs 108 from various manufacturers. In some cases, the second communication link 114 may also utilize open standards such as Open Platform Communications Unified Architecture (OPC UA) to facilitate interoperability between different OT systems. The data gateway 112 may serve as a bridge between the OT network and Information Technology (IT) networks, translating data from proprietary OT protocols into formats more readily usable by IT systems for analysis, reporting, or integration with higher-level business systems.

The data gateway 112 may be configured to collect, process, and transmit data from the PLC 108 to higher-level systems within the industrial facility 104. The data gateway 112 may perform protocol conversion, transforming data from OT-specific formats into standardized IT protocols such as MQTT, AMQP, or HTTP/REST. The data gateway 112 may also implement data filtering, aggregation, and compression techniques to optimize network bandwidth usage. In some cases, the data gateway 112 may provide local data storage and buffering capabilities to ensure data integrity during network interruptions. The data gateway 112 may support secure communication protocols and encryption methods to protect sensitive industrial data during transmission. Additionally, the data gateway 112 may offer features like data timestamping, quality tagging, and contextual enrichment to enhance the value of the transmitted information. The data gateway 112 may also facilitate bidirectional communication, allowing higher-level systems to send commands or configuration updates back to the PLC 108 or other field devices.

Furthermore, the environment 100 may include a Supervisory Control and Data Acquisition (SCADA) server 116 communicatively coupled to the data gateway 112. The SCADA server 116 may be coupled to the data gateway 112 via a third communication link 118. In an example, the third communication link 118 may include one of OT proprietary protocols and may vary based on the manufacturers of at least one of the data gateway 112 and the SCADA server 116. In another example, the third communication link 118 may include SCADA propriety protocol and may vary based on the manufacturers of the SCADA server 116. In yet another example, the third communication link 118 may be an Internet Protocol (IP) based communication link. For instance, the third communication link 118 may utilize Ethernet TCP/IP, which allows for high-speed data transfer and supports various industrial Ethernet protocols such as Modbus TCP/IP, EtherNet/IP, or Profinet. The IP-based communication may enable seamless integration with other network components and facilitate remote monitoring and control capabilities. Additionally, the use of IP-based protocols may allow for easier implementation of cybersecurity measures, such as encryption and virtual private networks (VPNs), to protect sensitive industrial data during transmission between the data gateway 112 and the SCADA server 116.

The SCADA server 116 may be configured to collect, process, and analyse data from multiple sources within the industrial facility 104, including the data gateway 112. The SCADA server 116 may provide a centralized platform for monitoring and controlling various industrial processes and assets. The SCADA server 116 may offer features such as real-time data visualization, historical data trending, alarm management, and report generation. In some examples, the SCADA server 116 may also implement advanced analytics and machine learning algorithms to predict equipment failures or optimize process efficiency. The communication between the data gateway 112 and the SCADA server 116 may be bidirectional, allowing the SCADA server 116 to send control commands or configuration updates back to the field devices through the data gateway 112.

Moreover, the environment 100 may include a Human-Machine Interface (HMI) 120 communicatively coupled to the SCADA server 116. The HMI 120 may be communicatively coupled to the HMI 120 via a fourth communication link 122. The fourth communication link 122 may be the IP based communication link. For instance, the fourth communication link 122 may utilize Ethernet TCP/IP, which is widely used in industrial settings for its reliability and high-speed data transfer capabilities. The IP-based connection may support various industrial Ethernet protocols such as EtherNet/IP, Profinet, or Modbus TCP/IP, depending on the specific requirements of the industrial facility 104.

The HMI 120 may be implemented as a dedicated hardware terminal, a PC-based software application, or even a mobile device, providing operators with real-time visualization of process data, system status, and control capabilities. The IP-based nature of the fourth communication link 122 may also facilitate remote access to the HMI 120, allowing authorized personnel to monitor and control industrial processes from off-site locations when necessary, subject to appropriate security measures.

The environment 100 may further include a plurality of network switches 124-1 and 124-2. In an example, the network switch 124-1 may be connected between the data gateway 112 and the SCADA server 116 and may facilitate the third communication link 118. In the example, the network switch 124-2 may be connected between the SCADA server 116 and the HMI 120 and may facilitate the fourth communication link 122. It would be noted that while the environment 100 has been illustrated to include two network switches 124-1 and 124-2, the environment 100 can include more than two network switches depending on the number of assets, PLCs, data gateways, and SCADA servers included in the environment 100. For the ease of reference, the plurality of network switches 124-1 and 124-2 has been referred to as the plurality of network switches 124, hereinafter.

The plurality of network switches 124-1 and 124-2 may be configured to route data packets between various components included in the environment 100, including the data gateway 112, SCADA server 116, and HMI 120. The network switches 124 may support features such as Virtual Local Area Networks (VLANs) for network segmentation, Quality of Service (QoS) for prioritizing critical traffic, and port mirroring for network monitoring. The network switches 124 may also implement security measures like access control lists (ACLs) and may support industrial protocols such as PROFINET, EtherNet/IP, or Modbus TCP/IP. Additionally, the network switches 124 switches may offer redundancy features like Rapid Spanning Tree Protocol (RSTP) or ring topologies to ensure high availability and minimize network downtime in the industrial networks.

It would be noted that the AHAS 102, the plurality of assets 106, the PLC 108, the data gateway 112, the SCADA server 116, the HMI 120, the plurality of network switches 124, and other hardware devices present within the industrial facility 104 may constitute an industrial network corresponding to the industrial facility 104.

In operation, the plurality of assets 106 may generate variables indicative of their operating parameters. The variables may include measurements such as temperature, pressure, flow rate, speed, or other process-specific parameters. The variables may then be transmitted from the plurality of assets 106 to the PLC 108 via the first communication link 110. The PLC 108 may receive and process the variables from the plurality of assets 106. The PLC 108 may perform initial data processing, such as scaling, filtering, or basic calculations on the received variables. The PLC 108 may then send the processed variables to the data gateway 112 through the second communication link 114. Upon receiving the variables, the data gateway 112 may perform additional processing on the variables, such as protocol conversion, data filtering, aggregation, or compression. In an example, the data gateway 112 may encapsulate the variables into data packets. The encapsulation may occur as part of the data gateway's function to bridge the OT network with Information Technology (IT) networks. The data gateway 112 may then transmit the data packets to the SCADA server 116 via the third communication link 118. This transmission may occur through the network switch 124-1, which routes the data packets containing the variables. Upon receiving the data packets, the SCADA server 116 may perform further processing, analysis, and storage of the variables. The SCADA server may also generate alarms or notifications based on the received variables. Finally, the processed and analysed variables are sent from the SCADA server 116 to the HMI 120 through the fourth communication link 122. This transmission may occur via the network switch 124-2. The HMI 120 may receive the variables and present them to operators in a visual format, allowing for real-time monitoring and control of the plurality of assets 106 based on their operating parameters.

In an example, the AHAS 102 may receive a plurality of data streams from the plurality of network switches 124. The plurality of data streams may include a plurality of data packets associated with an asset, such as the asset 106-1, where the plurality of data packets may include a plurality of variables indicative of operating parameters of the asset 106-1.

The AHAS 102 may then process the plurality of data streams for obtaining a first batch of pre-processed data packets corresponding to each of the plurality of data streams. The first batch of pre-processed data packets may include a first set of value of the first variable from the plurality of variables. Subsequently, the AHAS 102 may merge the first batch of pre-processed data packets corresponding to each of the plurality of data streams to obtain a second batch of data packets.

The AHAS 102 may then sort data packets within the second batch of data packets based at least on a timestamp of receiving a value of the first variable corresponding to each of the second batch of data packets to obtain a serialized ordered list of values. In an example, the timestamp may be indicative of a time of receiving the values of the first variable corresponding to each of the second batch of data packets at the data gateway 112. Thereafter, the AHAS 102 may utilize the serialized ordered list of values to compute at least one of a moving average of the first variable, a standard deviation with respect to the moving average, and maximum and minimum values of the first variable for generating an adaptive baseline for the first variable. The AHAS 102 may then reference the adaptive baseline for the first variable for determining an abnormality in functionality of the asset 106.

Subsequently, the AHAS 102 may determine a value of the first variable to be beyond the adaptive baseline. Based on the determination, the AHAS 102 may generate a notification indicating the abnormality in the functionality of the asset.

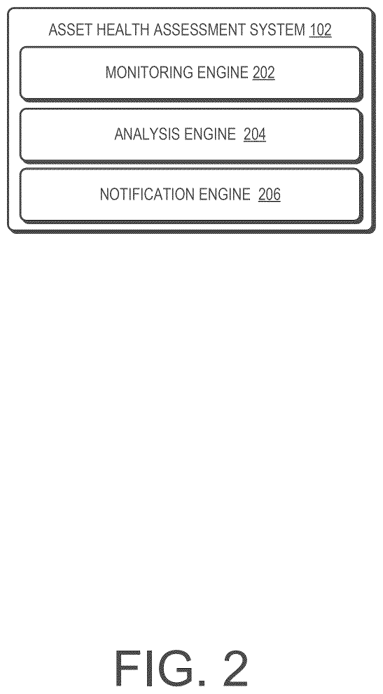

FIG. 2 illustrates schematic of the AHAS 102, in accordance with an example of the present subject matter.

The AHAS 102 may include a monitoring engine 202 to monitor a plurality of variables associated with an asset, such as the asset 106-1, where the plurality of variables is indicative of operating parameters of the asset 106-1.

The AHAS 102 may further include an analysis engine 204 coupled to the monitoring engine 202 to determine that a value of a first variable from the plurality of variables is beyond an adaptive baseline for the first variable. The adaptive baseline may be utilized for determining an abnormality in functionality of the asset 106-1.

In an example, the analysis engine 204 may generate the adaptive baseline. In the example, to generate the adaptive baseline, the analysis engine 204 may receive a plurality of data streams from a plurality of network switches 124. The data streams may include a plurality of data packets associated with the asset 106-1, where the plurality of data packets may contain the plurality of variables.

The analysis engine 204 may then process the data streams to obtain a first batch of pre-processed data packets for each of the plurality of data streams, merge the first batch of pre-processed data packets for each of the plurality of data streams to create a second batch of data packets, and sort the data packets within the second batch based on the timestamp of receiving the variable corresponding to each of the second batch of data packets to obtain a serialized ordered list of values. The analysis engine 204 may then utilize the serialized ordered list of values to compute at least one of the moving average of the first variable, the standard deviation, and the maximum and minimum values of the first variable for generating the adaptive baseline for the first variable.

The AHAS 102 may further include a notification engine 206 coupled to the analysis engine 204. In an example, when it is determined that a value of a first variable from the plurality of variables is beyond an adaptive baseline, the notification engine 206 may generate a notification indicating the abnormality in the functionality of the asset 106-1. The manner in which the AHAS 102 performs the asset health assessment is described in further details in conjunction with the forthcoming figures.

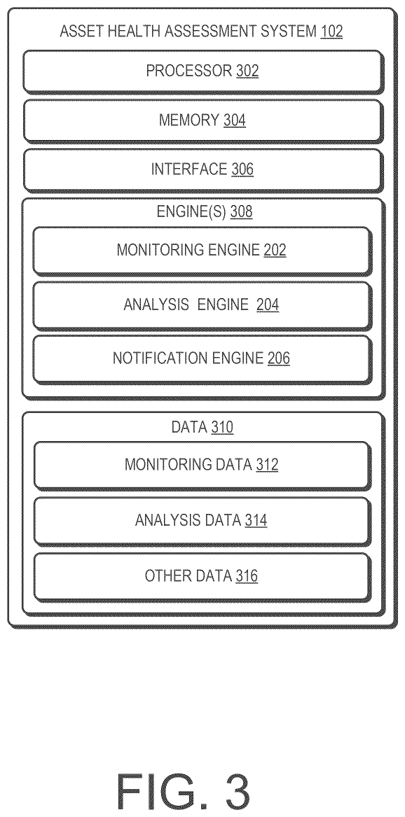

FIG. 3 illustrates the schematic of the AHAS 102, in accordance with another example of the present subject matter. As illustrated, the AHAS 102 may include a processor 302 and a memory 304 coupled to the processor 302. The functions of the various elements shown in the FIGs., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, conventional and/or custom, may also be included.

The memory 304 may include any computer-readable medium including, for example, volatile memory (e.g., RAM), and/or non-volatile memory (e.g., EPROM, flash memory, etc.).

The AHAS 102 may further include an interface 306. The interface 306 may allow the connection or coupling of the AHAS 102 with one or more other devices, through a wired (e.g., Local Area Network, i.e., LAN) connection or through a wireless connection (e.g., Bluetooth®, WiFi). The interface 306 may also enable intercommunication between different logical as well as hardware components of the AHAS 102. In some implementations, the interface 306 may include industrial-grade communication ports such as EtherNet/IP, Modbus TCP, or OPC UA for seamless integration with various industrial control systems. It may also support secure remote access protocols like SSH for maintenance and troubleshooting purposes.

The AHAS 102 may further include engine(s) 308, where the engine(s) 308 may include the monitoring engine 202, the analysis engine 204, and the notification engine 206 coupled to the analysis engine 204. In an example, the engine(s) 308 may be implemented as a combination of hardware and firmware or software. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions.

In the present examples, the machine-readable storage medium may store instructions that, when executed by the processing resource, implement the functionalities of the engine. In such examples, the AHAS 102 may include the machine-readable storage medium storing the instructions and the processing resource to execute the instructions. In other examples of the present subject matter, the machine-readable storage medium may be located at a different location but accessible to the AHAS 102 and the processor 302.

The AHAS 102 may further include data 310, that serves, amongst other things, as a repository for storing data that may be fetched, processed, received, or generated by the engine(s) 308. The data 310 may include monitoring data 312, analysis data 314, and other data 316. In an example, the data 312 may be stored in the memory 304.

In operation, the monitoring engine 202 may monitor the plurality of variables associated with the asset 106-1. As already described, the plurality of variables may be indicative of operating parameters of the asset 106-1. Thereafter, the analysis engine 204 may determine a value of the first variable. The monitoring engine 202 may then store the value of the first variable in the monitoring data 312. Thereafter, the monitoring engine 202 may determine if the value of the first variable is beyond the adaptive baseline for the first variable. As already described, the adaptive baseline may be utilized for determining an abnormality in functionality of the asset.

In an example, the analysis engine 204 may generate the adaptive baseline for the asset 106-1. In the example, to generate the adaptive baseline, the analysis engine 204 may receive the plurality of data streams from the plurality of network switches 124. The plurality of data streams may include a plurality of data packets associated with the asset 106-1 and the plurality of data packets may include the plurality of variables.

The analysis engine 204 may then process the plurality of data streams for obtaining the first batch of pre-processed data packets corresponding to each of the plurality of data streams. The analysis engine 204 may process the plurality of data streams in parallel. Parallel processing of the plurality of data streams allows multiple data streams to be handled simultaneously, significantly reducing the overall time required to process large volumes of data from the plurality of network switches.

In an example, to process the plurality of data streams, the analysis engine 204 may identify a first set of data packets for each of the plurality of data streams, where the first set of data packets is associated with the first variable. The analysis engine 204 may then remove data packets with duplicate values of the first variable from the first set of data packets to obtain the first batch of pre-processed data packets for each of the plurality of data streams. To remove the duplicate data packets from the first set of data packets, the analysis engine 204 may apply a first sampling rate to the first set of data packets, where the first sampling rate defines a frequency at which data packets are selected from the first set of data packets for processing. In one aspect, the first sampling rate applied may be based on the first variable. As would be understood, the sampling rate applied may vary in accordance with the variable being processed. In another aspect, the sampling rate may be pre-defined. In one example, a user may set the sampling rate to 5 seconds, or 10 seconds, or the like, based on the requirement. In yet another example, the first sampling rate may be based on historical data, for example, sampling rates applied for similar variables in the past, and the like. In one example, removal of data packets with duplicate values of the first variable from the first set of data packets may minimize the computational resources that may be required for further processing of the data packets. The analysis engine 204 may then store the first batch of pre-processed data packets for each of the plurality of data streams in the analysis data 314.

The analysis engine 204 may then merge the first batch of pre-processed data packets corresponding to each of the plurality of data streams to obtain a second batch of data packets. Thereafter, the analysis engine 204 may sort data packets within the second batch of data packets based at least on a timestamp of receiving the value of the first variable corresponding to each of the second batch of data packets to obtain a serialized ordered list of values. As already described, the timestamp may be indicative of a time of reception of the variables corresponding to each of the second batch of data packets at the data gateway 112.

In an example, prior to sorting the data packets within the second batch of data packets, the analysis engine 204 may also remove data packets with duplicate values of the first variable from the second batch of data packets. In the example, to remove the data packets with duplicate values of the first variable, the analysis engine 204 may apply a second sampling rate to the second batch of data packets. The second sampling rate defines a frequency at which data packets are selected from the second batch of data packets for processing.

In an example, the analysis engine 204 may also detect off-time for the asset 106-1. In an example, the analysis engine 204 may determine the off-time based on slope detection and off-state duration of the first variable. In another example, the analysis engine 204 may determine the off-time by applying moving window mechanism on the first variable. The analysis engine 204 may then exclude values of the first variable corresponding to the off-time while computing at least one of the moving average, the standard deviation, and the maximum and minimum values of the first variable.

The analysis engine 204 may then generate an adaptive baseline for the first variable. In an example, to generate the adaptive baseline for the first variable, the analysis engine 204 may utilize the serialized ordered list of values to compute at least one of the moving average of the first variable, the standard deviation, and the maximum and minimum values of the first variable. The analysis engine 204 may then reference the adaptive baseline for the first variable. Although the generation of the adaptive baseline is predominantly described with reference to the first variable, as would be understood, similar techniques of generating the adaptive baseline would be applicable for each variable of the plurality of variables.

In an example, the moving average may be Exponential Moving Average (EMA). In the example, to generate the adaptive baseline, the analysis engine 204 may compute the EMA, the standard deviation, and the minimum and maximum values of the first variable. To compute the EMA, the analysis engine 204 may initialize the EMA with a first value of the first variable. Thereafter, for each subsequent value, the analysis engine 204 may calculate the EMA as follows:

EMA=(Current value smoothing factor)+(Previous EMA (1 smoothing factor))
where the smoothing factor may be adjustable based on the desired responsiveness to recent data.

Further, to compute the standard deviation with respect to the moving average, the analysis engine 204 may use the calculated EMA values and the values of the first variable to determine the variance of the data from the moving average. The analysis engine 204 may also track the maximum and minimum values of the first variable encountered in the serialized ordered list of values. The minimum and maximum values may be continuously updated as new values are processed.

The analysis engine 204 may generate the adaptive baseline using moving window mechanism. To generate the adaptive baseline using the moving window mechanism, the analysis engine 204 may define a window size N, representing the number of most recent values to consider from the serialized ordered list of values. The analysis engine 204 may then initialize a circular buffer or queue of size N to store the most recent N values. Thereafter, for each new value in the serialized ordered list: the analysis engine 204 may add the new value to the circular buffer, replacing the oldest value if the buffer is full; calculate the moving average within the current window; compute the standard deviation with respect to the moving average using the values in the current window; and determine the maximum and minimum values within the current window. The moving window mechanism may allow the adaptive baseline to continuously adjust based on the most recent N values of the first variable, providing a dynamic reference point that evolves with the data stream.

In an example, the analysis engine 204 may determine that the value of the first variable is indeed beyond the adaptive baseline for the first variable. In the example, the notification engine 206 may generate a notification indicating the abnormality in the functionality of the asset.

In an illustrative example, the AHAS 102 may be implemented in a large-scale dairy processing plant to monitor the health of a milk pasteurization unit, which represents one of the assets 106-1. The first variable being monitored may be the pasteurization temperature in degrees Celsius (°C). The analysis engine 204 may receive data streams containing data packets with pasteurization temperature values sampled every 2 seconds. Using a moving window of the last 900 data points (representing 30 minutes of operation), the analysis engine 204 may generate an adaptive baseline for the pasteurization temperature.

In operation, at 8:00 AM, the exponential moving average (EMA) of the pasteurization temperature may be 72.1° C., with a standard deviation of 0.2° C. The maximum and minimum values in the current window may be 72.6° C. and 71.6° C. respectively. At 8:05 AM, a new value of 72.2° C. may be received. As the new value falls within the expected range of the maximum and minimum values, the new value may be utilized to update the adaptive baseline.

At 8:10 AM, the pasteurization temperature may suddenly drop to 71.2° C. As this value is more than 4 standard deviations below the current EMA (72.1° C.-(4 0.2° C.) =71.3° C.), the analysis engine 204 may detect the anomaly and determine it as an abnormality in the pasteurization unit's functionality. Accordingly, the notification engine 206 may generate an alert, indicating a potential issue with the pasteurization process temperature control.

In an example, in response to the notification, production engineers may investigate and discover that a steam valve supplying heat to the pasteurization unit has partially closed due to a control system malfunction. In the example, the engineers decide to temporarily shut down the pasteurization unit for maintenance. Accordingly, the pasteurization unit may be turned off at 8:15 AM and temperature may rapidly drop to 25° C. and remain stable. The analysis engine 204 may detect this off-time based on the sudden drop and stability of the temperature and may excludes the off-time values from the adaptive baseline calculations.

During the off-time, from 8:15 AM to 8:45 AM, the analysis engine 204 may not update the last known adaptive baseline with the off-time values. At 8:45 AM, the pasteurization unit may be restarted, and the temperature may begin to rise rapidly. The analysis engine 204 may detect the end of the off-time when the temperature rises above a predefined threshold, such as 50° C.

As the temperature stabilizes around the normal operating range, the analysis engine 204 may resume updating the adaptive baseline. For instance, at 9:00 AM, the EMA might be 72.0° C., with a new standard deviation of 0.3° C., and new maximum and minimum values of 72.5° C. and 71.5° C. The analysis engine 204 may continue to adjust the adaptive baseline as the pasteurization unit returns to normal operation, gradually incorporating the new data while excluding the off-time period.

The illustrative example demonstrates how the AHAS 102 uses real-time data and adaptive baselines to detect anomalies in food processing equipment, while also accounting for planned or unplanned off-time periods. By excluding off-time data, the AHAS 102 maintains an accurate representation of the asset's normal operating conditions, enabling more precise anomaly detection and ensuring consistent product quality in the dairy production process.

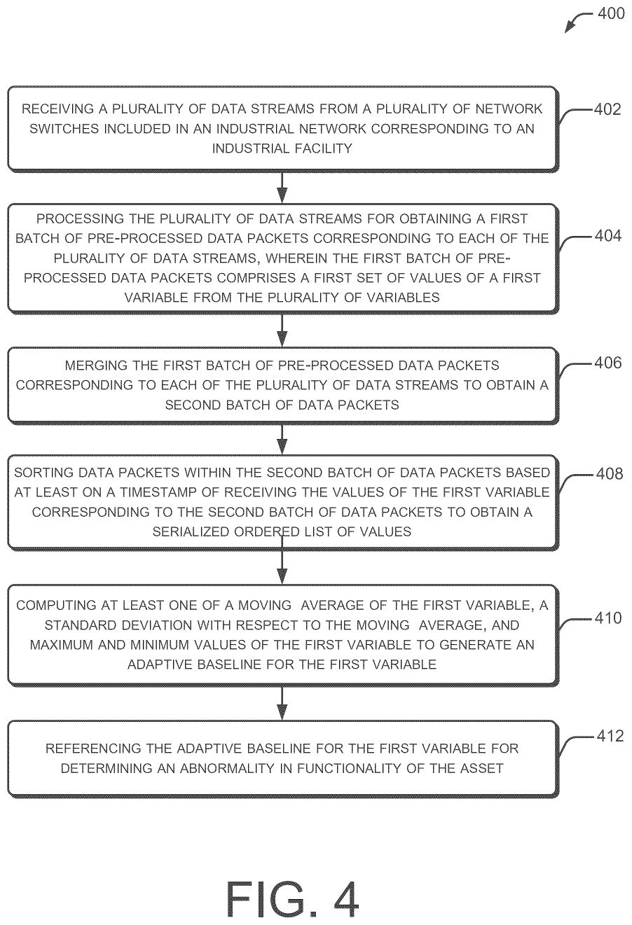

FIG. 4 to FIG. 9 illustrate methods for performing asset health assessment, in accordance with an example of the present subject matter. The order in which the method steps are described is not intended to be construed as a limitation, and any number of the described method blocks may be combined in any order to implement the methods, or an alternative method. Further, the methods may be implemented by processing resource or computing device(s) through any suitable hardware, non-transitory machine-readable instructions, or combination thereof.

It may also be understood that methods may be performed by programmed computing devices, such as the AHASs 102. Furthermore, the methods may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods are described below with reference to the AHAS 102, as described above; other suitable systems for the execution of these methods may also be utilized. Additionally, implementation of the methods is not limited to such examples.

In FIG. 4, at block 402, a plurality of data streams may be received from a plurality of network switches included in an industrial network corresponding to an industrial facility. The plurality of data streams may include a plurality of data packets associated with an asset within the industrial facility. Further, the plurality of data packets may include a plurality of variables indicative of operating parameters of the asset. In an example, plurality of data streams may be received by the analysis engine 204.

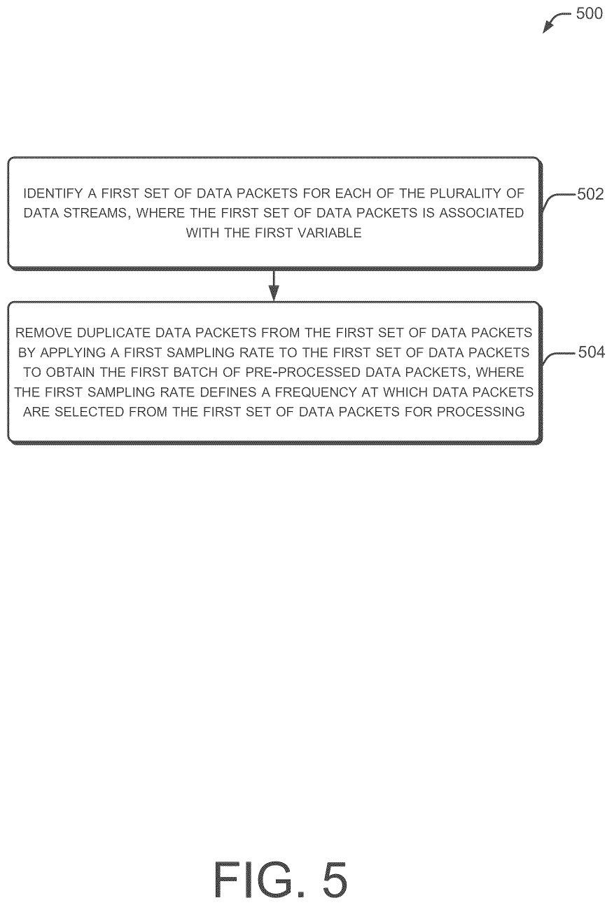

At block 404, the plurality of data streams may be processed for obtaining a first batch of pre-processed data packets corresponding to each of the plurality of data streams. The first batch of pre-processed data packets may comprise a first set of values of a first variable from the plurality of variables. In an example, the plurality of data streams may be processed in parallel. The plurality of data streams may be processed by the analysis engine 204. The manner in which the plurality of data streams is processed is described in conjunction with FIG. 5.

At block 406, the first batch of pre-processed data packets corresponding to each of the plurality of data streams may be merged to obtain a second batch of data packets. In an example, the merging may be performed by the analysis engine 204.

At block 408, data packets within the second batch of data packets may be sorted based at least on a timestamp of receiving the values of the first variable corresponding to the second batch of data packets to obtain a serialized ordered list of values. In an example, the sorting may be performed by the analysis engine 204.

At block 410, the serialized ordered list of values may be utilized to compute at least one of a moving average of the first variable, a standard deviation with respect to the moving average, and maximum and minimum values of the first variable for generating an adaptive baseline for the first variable. In an example, the computation may be performed by the analysis engine 204.

At block 412, the adaptive baseline for the first variable may be referenced for determining an abnormality in functionality of the asset. In an example, the referencing may be performed by the analysis engine 204.

In FIG. 5, at block 502, a first set of data packets may be identified for each of the plurality of data streams. The first set of data packets may be associated with the first variable. In an example, the identification may be performed by the analysis engine 204.

At block 504, data packets with duplicate values of the first variable may be removed from the first set of data packets to obtain the first batch of pre-processed data packets. To remove the data packets with duplicate values of the first variable, a first sampling rate may be applied to the first set of data packets to obtain the first batch of pre-processed data packets. The first sampling rate may define a frequency at which data packets are selected from the first set of data packets for processing. In one example, removal of data packets with duplicate values of the first variable minimizes the computational resources that may be required for further processing of the data packets. In an example, the removal of duplicate data packets may be performed by the analysis engine 204.

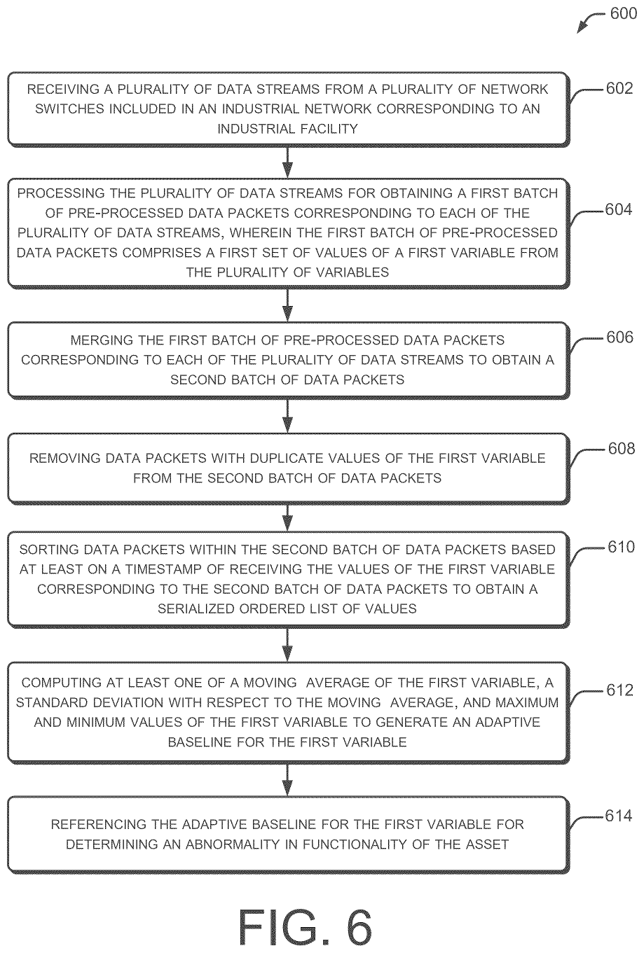

In FIG. 6, at block 602, a plurality of data streams may be received from a plurality of network switches included in an industrial network corresponding to an industrial facility. The plurality of data streams may include a plurality of data packets associated with an asset within the industrial facility. Further, the plurality of data packets may include a plurality of variables indicative of operating parameters of the asset. In an example, plurality of data streams may be received by the analysis engine 204.

At block 604, the plurality of data streams may be processed for obtaining a first batch of pre-processed data packets corresponding to each of the plurality of data streams. The first batch of pre-processed data packets may comprise a first set of values of a first variable from the plurality of variables. In an example, the plurality of data streams may be processed by the analysis engine 204. The manner in which the plurality of data streams is processed is described in conjunction with FIG. 5.

At block 606, the first batch of pre-processed data packets corresponding to each of the plurality of data streams may be merged to obtain a second batch of data packets. In an example, the merging may be performed by the analysis engine 204.

At block 608, data packets with duplicate values of the first variable may be removed from the second batch of data packets. The data packets with duplicate values may be removed by applying a second sampling rate to the second batch of data packets, where the second sampling rate defines a frequency at which data packets are selected from the second batch of data packets for processing. In an example, data packets with duplicate values may be removed by the analysis engine 204.

At block 610, data packets within the second batch of data packets may be sorted based at least on a timestamp of receiving the values of the first variable corresponding to the second batch of data packets to obtain a serialized ordered list of values. In an example, the sorting may be performed by the analysis engine 204.

At block 612, the serialized ordered list of values may be utilized to compute at least one of a moving average of the first variable, a standard deviation with respect to the moving average, and maximum and minimum values of the first variable for generating an adaptive baseline for the first variable. In an example, the computation may be performed by the analysis engine 204.

At block 614, the adaptive baseline for the first variable may be referenced for determining an abnormality in functionality of the asset. In an example, the referencing may be performed by the analysis engine 204.

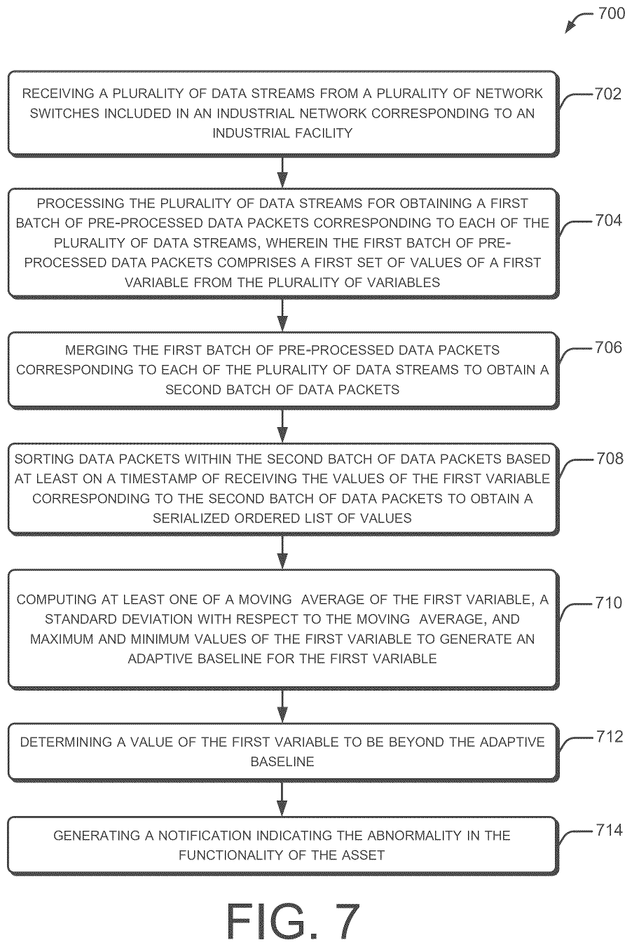

In FIG. 7, at block 702, a plurality of data streams may be received from a plurality of network switches included in an industrial network corresponding to an industrial facility. The plurality of data streams may comprise a plurality of data packets associated with an asset within the industrial facility, and the plurality of data packets may comprise a plurality of variables. In an example, plurality of data streams may be received by the analysis engine 204.

At block 704, the plurality of data streams may be processed for obtaining a first batch of pre-processed data packets corresponding to each of the plurality of data streams. The first batch of pre-processed data packets may comprise a first set of values of a first variable from the plurality of variables. The plurality of data streams may be processed by the analysis engine 204. Further, the manner in which the plurality of data streams is processed is described in conjunction with FIG. 5.

At block 706, the first batch of pre-processed data packets corresponding to each of the plurality of data streams may be merged to obtain a second batch of data packets. In an example, the merging may be performed by the analysis engine 204.

At block 708, data packets within the second batch of data packets may be sorted based at least on a timestamp of receiving values of the first variable corresponding to each of the second batch of data packets to obtain a serialized ordered list of values. In an example, the sorting may be performed by the analysis engine 204.

At block 710, the serialized ordered list of values may be utilized to compute at least one of a moving average of the first variable, a standard deviation with respect to the moving average, and maximum and minimum values of the first variable for generating an adaptive baseline for the first variable. The adaptive baseline may be utilized for determining an abnormality in the functionality of the asset. In an example, the computation may be performed by the analysis engine 204.

At block 712, a value of the first variable may be determined to be beyond the adaptive baseline. In an example, the value of the first variable may be determined to be beyond the adaptive baseline by the analysis engine 204.

At block 714, a notification indicating the abnormality in functionality of the asset may be generated. In an example, the notification may be generated by the notification engine 206.

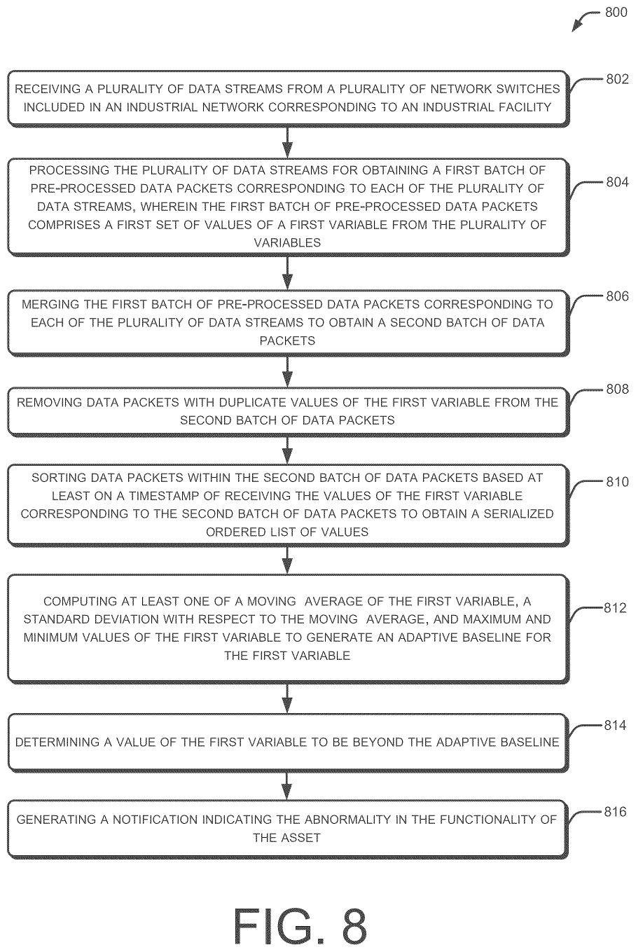

In FIG. 8, at block 802, a plurality of data streams may be received from a plurality of network switches included in an industrial network corresponding to an industrial facility. The plurality of data streams may comprise a plurality of data packets associated with an asset within the industrial facility, and the plurality of data packets may comprise a plurality of variables. In an example, plurality of data streams may be received by the analysis engine 204.

At block 804, the plurality of data streams may be processed for obtaining a first batch of pre-processed data packets corresponding to each of the plurality of data streams. The first batch of pre-processed data packets may comprise a first set of values of a first variable from the plurality of variables. The plurality of data streams may be processed by the analysis engine 204. The manner in which the plurality of data streams is processed is described in conjunction with FIG. 5.

At block 806, the first batch of pre-processed data packets corresponding to each of the plurality of data streams may be merged to obtain a second batch of data packets. In an example, the merging may be performed by the analysis engine 204.

At block 808, data packets with duplicate values of the first variable may be removed from the second batch of data packets. The data packets with duplicate values may be removed by applying a second sampling rate to the second batch of data packets, where the second sampling rate defines a frequency at which data packets are selected from the second batch of data packets for processing. In an example, data packets with duplicate values may be removed by the analysis engine 204.

At block 810, data packets within the second batch of data packets may be sorted based at least on a timestamp of receiving values of the first variable corresponding to each of the second batch of data packets to obtain a serialized ordered list of values. In an example, the sorting may be performed by the analysis engine 204.

At block 812, the serialized ordered list of values may be utilized to compute at least one of a moving average of the first variable, a standard deviation with respect to the moving average, and maximum and minimum values of the first variable for generating an adaptive baseline for the first variable. The adaptive baseline may be utilized for determining an abnormality in the functionality of the asset. In an example, the computation may be performed by the analysis engine 204.

At block 814, a value of the first variable may be determined to be beyond the adaptive baseline. In an example, the value of the first variable may be determined to be beyond the adaptive baseline by the analysis engine 204.

At block 816, a notification indicating the abnormality in functionality of the asset may be generated. In an example, the notification may be generated by the notification engine 206.

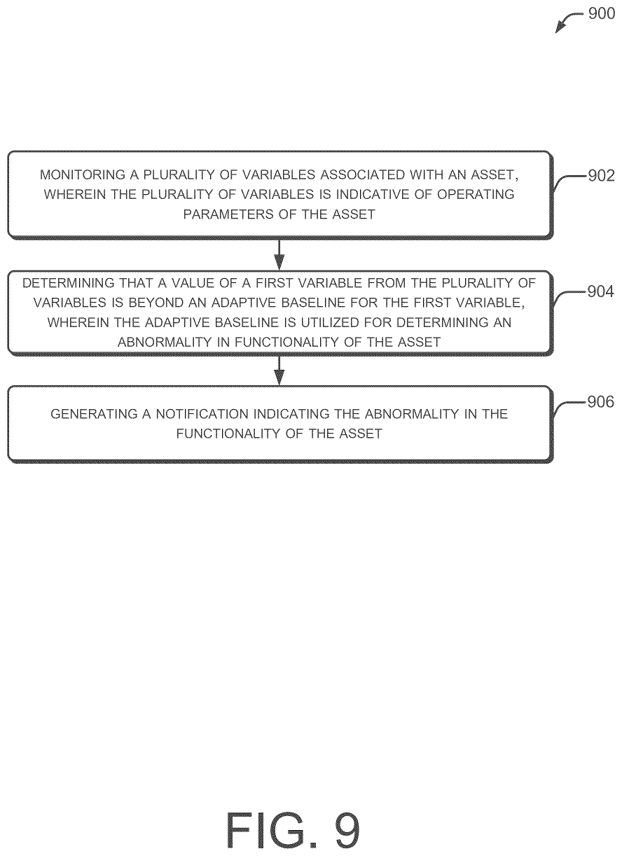

In FIG. 9, at block 902, a plurality of variables associated with an asset may be monitored. The plurality of variables is indicative of operating parameters of the asset. In an example, the plurality of variables may be monitored by the monitoring engine 202.

At block 904, a value of a first variable from the plurality of variables may be determined to be beyond an adaptive baseline for the first variable. The adaptive baseline may be utilized for determining an abnormality in functionality of the asset. In an example, the value of the first variable may be determined to be beyond the threshold by the analysis engine 204.

In an example, the method may also include generating the adaptive baseline for the first variable. In the example, to generate the adaptive baseline, a plurality of data streams may be received from a plurality of network switches included in an industrial network corresponding to an industrial facility. The plurality of data streams may include a plurality of data packets associated with an asset within the industrial facility. Further, the plurality of data packets may include a plurality of variables indicative of operating parameters of the asset. The plurality of data streams may then be processed for obtaining a first batch of pre-processed data packets corresponding to each of the plurality of data streams. The first batch of pre-processed data packets may comprise a first set of values of a first variable from the plurality of variables. The first batch of pre-processed data packets corresponding to each of the plurality of data streams may then be merged to obtain a second batch of data packets. Thereafter, data packets within the second batch of data packets may be sorted based at least on a timestamp of receiving the values of the first variable corresponding to the second batch of data packets to obtain a serialized ordered list of values. Subsequently, the serialized ordered list of values may be utilized to compute at least one of a moving average of the first variable, a standard deviation with respect to the moving average, and maximum and minimum values of the first variable for generating the adaptive baseline for the first variable.

At block 906, a notification indicating the abnormality in the functionality of the asset may be generated. In an example, the notification may be generated by the notification engine 206.

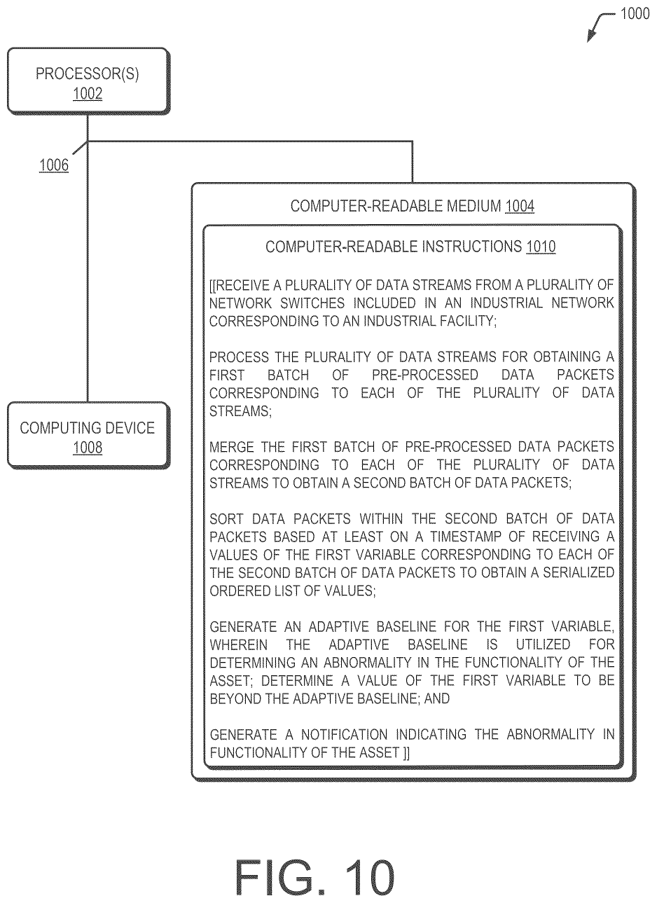

FIG. 10 illustrates a non-transitory computer-readable medium for performing asset health assessment, in accordance with an example of the present subject matter.

In an example, the computing environment 1000 includes processor 1002 communicatively coupled to a non-transitory computer readable medium 1004 through communication link 1006. In an example implementation, the computing environment 1000 may be for example, the AHAS 102. In an example, the processor 1002 may have one or more processing resources for fetching and executing computer-readable instructions from the non-transitory computer readable medium 1004. The processor 1002 and the non-transitory computer readable medium 1004 may be implemented, for example, in the AHAS 102.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 1004 includes a set of computer readable instructions 1010 which may be accessed by the processor 1002 through the communication link 1006 and subsequently executed for determining the anomaly in the operation of the asset. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to receive a plurality of data streams from a plurality of network switches included in an industrial network corresponding to an industrial facility. The plurality of data streams includes a plurality of data packets associated with an asset within the industrial facility. Further, the plurality of data packets includes a plurality of variables.

The instructions 1010 further cause the processor 1002 to process the plurality of data streams for obtaining a first batch of pre-processed data packets corresponding to each of the plurality of data streams. The first batch of pre-processed data packets comprises a first set of values of a first variable from the plurality of variables. The instructions 1010 causes the processor 1002 to process the plurality of data streams in parallel.

In an example, to process each of the plurality of data streams, the instructions 1010 cause the processor 1002 to identify a first set of data packets for each of the plurality of data streams, where the first set of data packets are associated with the first variable. In the example, the instructions 1010 further cause the processor 1002 to remove data packets with duplicate values of the first variable from the first set of data packets. The instructions 1010 cause the processor 1002 to apply a first sampling rate to the first set of data packets to obtain the first batch of pre-processed data packets, where the first sampling rate defines a frequency at which data packets are selected from the first set of data packets for processing.

The instructions 1010 then causes the processor 1002 to merge the first batch of pre-processed data packets corresponding to each of the plurality of data streams to obtain a second batch of data packets. Thereafter, the instructions 1010 causes the processor 1002 to sort data packets within the second batch of data to obtain a serialized ordered list of values. The instructions 1010 causes the processor 1002 to sort the data packets based at least on a timestamp of receiving a values of the first variable corresponding to each of the second batch of data packets.

In an example, prior to sorting the data packets within the second batch of data packets, the instructions 1010 causes the processor 1002 to remove data packets with duplicate values of the first variable from the second batch of data packets by applying a second sampling rate to the second batch of data packets, where the second sampling rate defines a frequency at which data packets are selected from the second batch of data packets for processing.

The instructions 1010 may then cause the processor 1002 to utilize the serialized ordered list of values to compute at least one of a moving average of the first variable, a standard deviation with respect to the moving average, and maximum and minimum values of the first variable for generating an adaptive baseline for the first variable. The adaptive baseline is utilized for determining an abnormality in the functionality of the asset.

In an example, the instructions 1010 may cause the processor 1002 to detect off-time for the asset based on at least one of slope detection and off-state duration of the first variable. In the example, while generating the adaptive baseline, the instructions 1010 may cause the processor 1002 to exclude values of the first variable corresponding to the off-time while computing at least one of the moving average, the standard deviation, and the maximum and minimum values.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method comprising:
receiving a plurality of data streams from a plurality of network switches included in an industrial network corresponding to an industrial facility, wherein the plurality of data streams comprises a plurality of data packets associated with an asset within the industrial facility, and the plurality of data packets comprises a plurality of variables indicative of operating parameters of the asset;
processing the plurality of data streams for obtaining a first batch of pre-processed data packets corresponding to each of the plurality of data streams, wherein the first batch of pre-processed data packets comprises a first set of values of a first variable from the plurality of variables;
merging the first batch of pre-processed data packets corresponding to each of the plurality of data streams to obtain a second batch of data packets;
sorting data packets within the second batch of data packets based at least on a timestamp of receiving the values of the first variable corresponding to the second batch of data packets to obtain a serialized ordered list of values;
utilizing the serialized ordered list of values to compute at least one of a moving average of the first variable, a standard deviation with respect to the moving average, and maximum and minimum values of the first variable for generating an adaptive baseline for the first variable;
referencing the adaptive baseline for the first variable for determining an abnormality in functionality of the asset.

2. The method of claim 1, further comprising:
determining a value of the first variable to be beyond the adaptive baseline; and
generating a notification indicating the abnormality in the functionality of the asset.

3. The method of claim 1, wherein processing the plurality of data streams comprises processing each of the plurality of data streams in parallel.

4. The method of claim 1, wherein the processing comprises:
identifying a first set of data packets for each of the plurality of data streams, wherein the first set of data packets are associated with the first variable; and
removing data packets with duplicate values of the first variable from the first set of data packets to obtain the first batch of pre-processed data packets.

5. The method of claim 4, wherein removing data packets with duplicate values of the first variable comprises applying a first sampling rate to the first set of data packets to obtain the first batch of pre-processed data packets, wherein the first sampling rate defines a frequency at which data packets are selected from the first set of data packets for processing.

6. The method of claim 5, wherein prior to sorting the data packets within the second batch of data packets, the method comprises removing data packets with duplicate values of the first variable from the second batch of data packets, wherein the removing comprises applying a second sampling rate to the second batch of data packets, wherein the second sampling rate defines a frequency at which data packets are selected from the second batch of data packets for processing.

7. The method of claim 1, wherein the method comprises detecting off-time for the asset, wherein the off-time is detected based on slope detection and off-state duration of the first variable.

8. The method of claim 7, wherein generating the adaptive baseline for the first variable comprises excluding values of the first variable corresponding to the off-time while computing at least one of the moving average, the standard deviation, and the maximum and minimum values.

9. An Asset Health Assessment system (AHAS) comprising:
a monitoring engine to monitor a plurality of variables associated with an asset, wherein the plurality of variables is indicative of operating parameters of the asset;
an analysis engine coupled to the monitoring engine to determine that a value of a first variable from the plurality of variables is beyond an adaptive baseline for the first variable, wherein the adaptive baseline is utilized for determining an abnormality in functionality of the asset, and wherein to generate the adaptive baseline, the analysis engine is to:
receive a plurality of data streams from a plurality of network switches included in an industrial network corresponding to an industrial facility, wherein the plurality of data streams comprises a plurality of data packets associated with an asset within the industrial facility, and the plurality of data packets comprises the plurality of variables;
process the plurality of data streams for obtaining a first batch of pre-processed data packets corresponding to each of the plurality of data streams, wherein the first batch of pre-processed data packets comprises a first set of values of the first variable;
merge the first batch of pre-processed data packets corresponding to each of the plurality of data streams to obtain a second batch of data packets;
sort data packets within the second batch of data packets based at least on a timestamp of receiving a value of the first variable corresponding to each of the second batch of data packets to obtain a serialized ordered list of values; and
utilizing the serialized ordered list of values to compute at least one of a moving average of the first variable, a standard deviation with respect to the moving average, and maximum and maximum values of the first variable for generating the adaptive baseline for the first variable; and
a notification engine coupled to the analysis engine to generate a notification indicating the abnormality in the functionality of the asset.

10. The AHAS of claim 9, wherein the analysis engine is to process each of the plurality of data streams in parallel.

11. The AHAS of claim 9, wherein to process each of the plurality of data streams, the analysis engine is to:
identify a first set of data packets for each of the plurality of data streams, wherein the first set of data packets is associated with the first variable; and
remove data packets with duplicate values of the first variable from the first set of data packets by applying a first sampling rate to the first set of data packets to obtain the first batch of pre-processed data packets, wherein the first sampling rate defines a frequency at which data packets are selected from the first set of data packets for processing.

12. The AHAS of claim 11, wherein the analysis engine is to remove data packets with duplicate values of the first variable from the second batch of data packets by applying a second sampling rate to the second batch of data packets, wherein the second sampling rate defines a frequency at which data packets are selected from the second batch of data packets for processing.

13. The AHAS of claim 9, wherein the analysis engine is to detect off-time for the asset based on slope detection and off-state duration of the first variable.

14. The AHAS of claim 13, wherein to generate the adaptive baseline for the first variable, the analysis engine is to exclude values of the first variable corresponding to the off-time while computing at least one of the moving average, the standard deviation, and the maximum and minimum values.

15. A non-transitory computer readable medium comprising computer-readable instructions that when executed cause a processing resource of a computing device to:
receive a plurality of data streams from a plurality of network switches included in an industrial network corresponding to an industrial facility, wherein the plurality of data streams comprises a plurality of data packets associated with an asset within the industrial facility, and the plurality of data packets comprises a plurality of variables;
process the plurality of data streams for obtaining a first batch of pre-processed data packets corresponding to each of the plurality of data streams, wherein the first batch of pre-processed data packets comprises a first set of values of a first variable from the plurality of variables;
merge the first batch of pre-processed data packets corresponding to each of the plurality of data streams to obtain a second batch of data packets;
sort data packets within the second batch of data packets based at least on a timestamp of receiving a values of the first variable corresponding to each of the second batch of data packets to obtain a serialized ordered list of values;
utilize the serialized ordered list of values to compute at least one of a moving average of the first variable, a standard deviation with respect to the moving average, and maximum and minimum values of the first variable for generating an adaptive baseline for the first variable, wherein the adaptive baseline is utilized for determining an abnormality in functionality of the asset;
determine a value of the first variable to be beyond the adaptive baseline; and
generate a notification indicating the abnormality in functionality of the asset.

16. The non-transitory computer readable medium of claim 15, wherein the instructions cause the computing device to process each of the plurality of data streams in parallel.

17. The non-transitory computer readable medium of claim 15, wherein to process each of the plurality of data streams, the instructions cause the computing device to:
identify a first set of data packets for each of the plurality of data streams, wherein the first set of data packets are associated with the first variable; and
remove data packets with duplicate values of the first variable from the first set of data packets by applying a first sampling rate to the first set of data packets to obtain the first batch of pre-processed data packets, wherein the first sampling rate defines a frequency at which data packets are selected from the first set of data packets for processing.

18. The non-transitory computer readable medium of claim 15, wherein prior to sorting the data packets within the second batch of data packets, the instructions cause the computing device to remove data packets with duplicate values of the first variable from the second batch of data packets by applying a second sampling rate to the second batch of data packets, wherein the second sampling rate defines a frequency at which data packets are selected from the second batch of data packets for processing.

19. The non-transitory computer readable medium of claim 15, wherein the instructions cause the computing device to detect off-time for the asset based on at least one of slope detection and off-state duration of the first variable.

20. The non-transitory computer readable medium of claim 19, wherein to generate the adaptive baseline for the first variable, the instructions cause the computing device to exclude values of the first variable corresponding to the off-time while computing at least one of the moving average, the standard deviation, and the maximum and minimum values.
